(19) United States
(12) Patent Application Publication
(10) Pub. No.: US 2015/0170123 A1
(43) Pub. Date: Jun. 18, 2015

(54) SYSTEM AND METHOD FOR FACILITATING ONLINE TRANSACTIONS USING MOBILE PHONE ACCOUNT

(71) Applicant: Siru Mobile Oy, Helsinki (FI)

(72) Inventors: Timo Hakanpää, Piispanristi (FI); Ilkka Seppänen, Turku (FI)

(73) Assignee: Siru Mobile Oy, Helsinki (FI)

(21) Appl. No.: 14/133,523

(22) Filed: Dec. 18, 2013

(51) Int. Cl. G06Q 20/16; H04W 4/14; G06Q 20/20; H04M 1/725

(52) U.S. Cl. CPC G06Q 20/16; H04M 1/72519; H04W 4/14; G06Q 20/206

(57) ABSTRACT

The present disclosure provides a payment management system for processing electronic payments between user and merchant terminals, and is operable to receive a payment request from the merchant terminal for the payment of one or more goods and services, display a premium rate phone number on the user terminal, receive an incoming call for the premium rate phone number, answer the caller with a predefined audio message, hold the incoming call for at least first predefined time period when the mobile phone number of the caller is same as the mobile phone number in the payment request, receive a confirmation message regarding successful completion of the call to the premium rate phone number, charge the mobile phone service provider for the payment of one or more goods and services, and pay the merchant terminal for the one or more goods and services.

The present disclosure generally relates to online payment systems, and more specifically relates to facilitating online transactions using a mobile phone account of a user, the present disclosure is, for example, concerned with systems and methods for facilitating online transactions using premium rate phone numbers. Moreover, aspects of the disclosure are also directed to software products recorded on machine-readable data storage media, wherein such software products are executable upon computing hardware, to implement the aforesaid methods of the disclosure.

### BACKGROUND

With the advent of the Internet, there has been a substantial increase in online purchase of goods and services. Most online purchases provide options to the customers to pay using their credit/debit cards, in which the customer is instructed to fill in an appropriate form and specify their personal and credit/debit card details after selecting the goods or service to purchase. As a result, the sensitive personal and financial details of a user are transmitted to the credit/debit card provider over the Internet for further verification and payment. If the credit/debit card details are acquired fraudulently by a third person, such third person may freely use these details for their online transactions. Although, there exists several online security mechanisms that ensure confidentiality of the credit/debit card details, there always remains a risk and fear in the user's mind regarding the security of the transmission of the credit/debit card details, and they may be reluctant to use their credit/debit card for online transactions.

Additionally, it is cumbersome for a user to remember and enter the credit/debit card details every time they want to carry out an online transaction. Also, there are many users who want to do online shopping, but do not own or qualify for a credit card, and thus not able to do online purchases.

Premium rate phone numbers are phone numbers on which the user can call or send an SMS to purchase some services/product. A call to a premium rate phone number is charged higher than a call to a normal phone number, and a part of the call charge is provided to the service provider. For example, in soft-drink vending machines, there is a premium rate phone number written on the vending machine. When a person wants to purchase a soft drink of a predefined cost, he may call the premium rate phone number from their mobile phone and specify the product, i.e soft-drink he wants to purchase. When the call is verified, funds from users postpaid/pre-paid mobile number account are deducted, and a message is sent to the vending machine regarding successful payment of the user for the soft drink. Accordingly, the vending machine may dispense the soft drink to the user. However, there does not exist any system that facilitates online transactions using premium rate phone numbers.

Hence, there is a need for a system and method that facilitates online transactions in a safe, secure and simple manner without necessarily requiring the use of a credit/debit card.

### SUMMARY

The present disclosure seeks to provide a payment management system for processing electronic payments between user and merchant terminals, and a method of operating the same.

In one aspect, embodiments of the present disclosure provide a payment management system for processing electronic payments between user and merchant terminals. The payment management system includes a computing hardware coupled in communication via a communication network to the user and merchant terminals, and a mobile phone service provider, and is operable to execute one or more software products for providing a graphical user interface on the user terminal. The computing hardware of the payment management system is operable to receive from the merchant terminal, a payment request for one or more goods and services, wherein the payment request includes a mobile phone number of a user, and a display of a premium rate phone number and an instruction to call the premium rate phone number from a mobile phone of the user on the user terminal, wherein the premium rate phone number is associated with a value of the one or more goods and services. The computing hardware is further operable to receive an incoming call for the premium rate phone number, wherein the incoming call is forwarded by the mobile phone service provider when a mobile phone account of a caller has sufficient funds to pay for the call to the premium rate phone number, answer the caller with a predefined audio message, and verify whether a mobile phone number of the caller is same as the mobile phone number in the payment request. The computing hardware is furthermore operable to hold the incoming call for at least first predefined time period, when the mobile phone number of the caller is same as the mobile phone number in the payment request, and receive a confirmation message from a mobile phone service provider that the incoming call is successfully completed and the mobile phone account of the user is debited. The computing hardware is furthermore operable to charge the mobile phone service provider for the payment of the one or more goods and services when the mobile phone account of the user is debited, and pay the merchant terminal for the one or more goods and services.

The payment management system is further operable to decline the payment to the merchant terminal, when the user does not call the premium rate phone number within a second predefined time period, and/or when the user does not have sufficient funds in corresponding mobile phone account, and/or when the caller of the premium rate phone number is not same as the user, and/or when the user terminates the outgoing call to the premium rate phone number before the expiry of the first predefined time period.

The payment management system is further operable to terminate the incoming call to the premium rate phone number before the expiry of the first predefined time period, when the mobile phone number of the caller is not same as the mobile phone number in the payment request.

The payment management system is further operable to access at least one database that stores the mobile phone number of the user, and corresponding premium rate phone number and the payment request.

The payment management system is further operable to send a short message service (SMS) to the mobile phone of the user before displaying the premium rate phone number on the user terminal, wherein the SMS includes a verification code for enabling the user to enter the verification code in a predefined field on the graphical user interface of the user terminal.

The payment management system is further operable to display on the user terminal, a status update of the call between the mobile phone number of the user and the premium rate phone number, when the user calls at the premium rate phone number from their mobile phone.

The user terminal is a computing device implemented using at least one of: a laptop, a personal computer, a tablet computer, a phablet computer, a webpad, a wearable computer, a wrist-worn computer, and a smart phone.

In another aspect, embodiments of the present disclosure provide a method for processing electronic payments between user and merchant terminals through a payment management system.

In yet another aspect, embodiments of the present disclosure provide a software product recorded on a non-transient machine-readable data storage media, such that the software product is executable upon the computing hardware of the payment management system for implementing the method of processing electronic payments between the user and merchant terminals.

Embodiments of the present disclosure provide a payment management system that processes electronic payments between the user and merchant terminals for one or more goods and services, using a mobile phone account of a user. The payment management system enables the user to call a premium rate phone number using their mobile phone, wherein the call charges for the premium rate phone number cover the cost of one or more goods and services. As a result, the payment of the one or more goods and services is done from the mobile phone account of the user, instead of a credit/debit card of the user. Thus, the payment management system of the present invention facilitates electronic payments in a safe, secure and simple manner without necessarily requiring the use of a credit/debit card.

Additional aspects, advantages, features and objects of the present disclosure would be made apparent from the drawings and the detailed description of the illustrative embodiments construed in conjunction with the appended claims that follow.

It will be appreciated that features of the invention are susceptible to being combined in various combinations without departing from the scope of the invention as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the invention is not limited to specific methods and instrumentalities disclosed herein. Moreover, those in the art will understand that the drawings are not to scale. Wherever possible, like elements have been indicated by identical numbers.

FIG. 1 is an illustration of an environment that is suitable for practicing various implementations of the present disclosure;

FIG. 2 is an illustration of communication between various entities of the environment for processing electronic payments between the web browser and the web shop, in accordance with an embodiment of the present disclosure;

FIG. 3 is an illustration of an exemplary web page of the web shop, displayed in the web browser, in accordance with the present disclosure;

FIG. 4 is an illustration of another exemplary web page of the web shop, displayed in the web browser, in accordance with the present disclosure.

FIGS. 5a-5c are an illustration of exemplary web pages of the payment management system, displayed in the web browser, in accordance with the present disclosure.

FIGS. 6a-6o are an illustration of exemplary user interfaces of a smart phone while processing electronic payments using the payment management system, in accordance with the present disclosure; and

FIG. 7 is an illustration of steps of a method of processing electronic payments through a payment management system, in accordance with the present disclosure.

### DETAILED DESCRIPTION OF ILLUSTRATIVE EMBODIMENTS

The following detailed description illustrates embodiments of the disclosure and ways in which it can be implemented. Although the best mode of carrying out the invention has been disclosed, those in the art would recognize that other embodiments for carrying out or practicing the invention are also possible.

In overview, a payment management system for processing electronic payments between user and merchant terminals is provided. The payment management system includes a computing hardware coupled in communication via a communication network to the user and merchant terminals, and a mobile phone service provider, and is operable to execute one or more software products for providing a graphical user interface on the user terminal. The computing hardware of the payment management system is operable to receive from the merchant terminal, a payment request for one or more goods and services, wherein the payment request includes a mobile phone number of a user, and a display of a premium rate phone number and an instruction to call the premium rate phone number from a mobile phone of the user on the user terminal, wherein the premium rate phone number is associated with a value of the one or more goods and services. The computing hardware is further operable to receive an incoming call for the premium rate phone number, wherein the incoming call is forwarded by the mobile phone service provider when a mobile phone account of a caller has sufficient funds to pay for the call to the premium rate phone number, answer the caller with a predefined audio message, and verify whether a mobile phone number of the caller is same as the mobile phone number in the payment request. The computing hardware is furthermore operable to hold the incoming call for at least first predefined time period, when the mobile phone number of the caller is same as the mobile phone number in the payment request, and receive a confirmation message from a mobile phone service provider that the incoming call is successfully completed and the mobile phone account of the user is debited for the outgoing call to the premium rate phone number. The computing hardware is furthermore operable to charge the mobile phone service provider for the payment of the one or more goods and services when the mobile phone account of the user is debited, and pay the merchant terminal for the one or more goods and services.

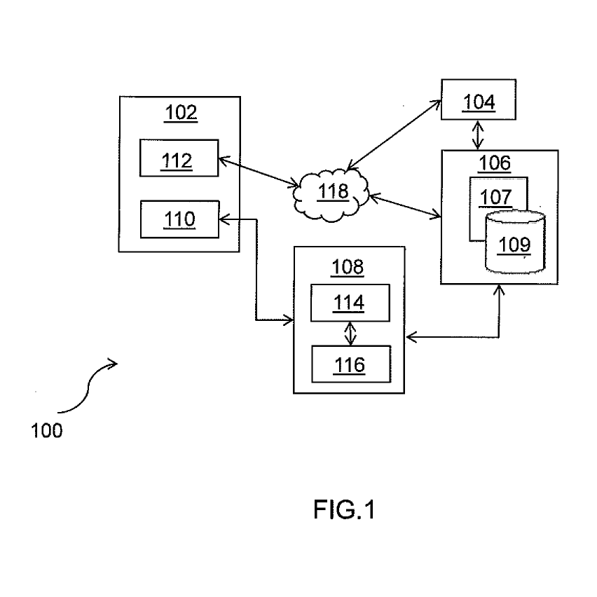

Referring now to the drawings, particularly by their reference numbers, FIG. 1 is an illustration of an environment 100 that is suitable for practicing various implementations of the present disclosure. The environment 100 includes a user device 102, i.e. a user terminal, a web shop 104, i.e. a merchant terminal for enabling a user to purchase one or more services/products online, a payment management system 106 for enabling the user to pay for the services/products, a mobile phone operator infrastructure 108 in communication with the payment management system 106 for facilitating payment of the service/products from a mobile phone account associated with a mobile number of the user.

The web shop 104 is a website/webpage that may include multiple services/products along with their prices. Examples of services/products include, but are not limited to, online gaming, on-demand videos and music, video conferencing, and online shopping.

The payment management system 106 includes at least one server 107, which is an example of a computing hardware, and at least one database 109. The server 107 is operable to execute one or more software products for processing online transactions between the user device 102 and the web shop 104 using the mobile phone account of the user. The server 107 is further operable to access the at least one database 109 for processing the online transactions.

The user device 102 includes a mobile phone 110 and a web browser 112. The mobile phone 110 is communicatively coupled to the mobile phone operator infrastructure 108 and holds a mobile phone account with the mobile phone operator infrastructure 108 for making phone calls and sending Short Message Service (SMS) to other users. The mobile phone account may be either a postpaid account or a prepaid account, and may be recharged by the user by means of netbanking, credit card, debit card, cash, etc.

In an embodiment, the mobile phone operator infrastructure 108 includes a phone call routing logic 114 such as base stations, home location registers, phone lines etc, for enabling the user to make phone calls and send SMS to other users, and a call detail record (CDR)/billing/transaction follow up system 116 to maintain a record of usage of the mobile number associated with the mobile phone 110, user transactions, balance in the mobile phone account, etc.

In an embodiment, the web browser 112 executes on a display of the mobile phone 110 when it is a smart phone. In another embodiment, the web browser 112 executes on a display of a computing device such as laptop, personal computers, tablets, phablets, webpad, wearable computers, and wrist-worn computers when the mobile phone 110 is not a smart phone. In both the embodiments, the web browser 112 is configured to connect to the web shop 104 and the payment management system 106 over the communication network 118 such as Internet using communication means such as WiFi, WLAN, cellular (2G, 3G, LTE etc).

FIG. 1 is merely an example, which should not unduly limit the scope of the claims herein. One of ordinary skill in the art would recognize many variations, alternatives, and modifications of embodiments herein.

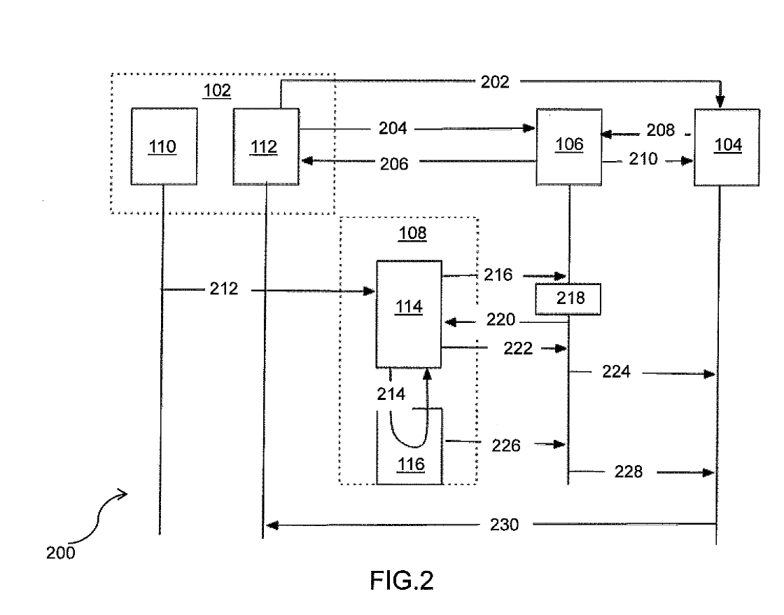

FIG. 2 is an illustration of communication 200 between various entities of the environment 100 for processing electronic payments between the web browser 112 and the web shop 104, using the mobile phone account of the user, in accordance with an embodiment of the present disclosure.

In step 202, a request is sent to a server of the web shop 104 for displaying at least one web page of the web shop 104 in the web browser 112, by entering a Uniform Resource Locator (URL) of the web shop 104 in the web browser 112. The web pages may include redirects and other Hypertext markup language (HTML) information such as text, figures, videos, images, and scripts, and may display a list of goods and services along with their prices. When a user selects at least one good/service, he may be redirected to a payment page, which illustrates the payment management system 106 as a payment option along with other payment options such as credit card, debit card, netbanking, etc. Along with the payment options, the payment page may include a predefined field for prompting the user to fill in their mobile phone number.

In step 204, a payment request is sent from the web browser 112 to the payment management system 106, by selecting the payment management system 106 as the payment option and entering the mobile phone number in the predefined field. The mobile phone number may either be entered manually by a user or automatically, and the payment request may include the details of the selected goods/services, details of the web shop 104 and the mobile phone number of the user. In an embodiment, the payment request is sent from the web browser 112 to the payment management system 106 directly over the web interface (for example HTTP post message) or via the webshop 104.

In step 206, the payment management system 106 displays a premium rate phone number in the web browser 112, after it receives the payment request from the web browser 112. The premium rate phone number is associated with a value of the selected goods/services, and the call charges to the premium rate phone number are sufficient to cover the cost of the selected goods/services. In an embodiment, as soon as the user enters their mobile phone number in the predefined field in the step 204, the web browser 112 displays a web page of the payment management system 106 that includes the premium rate phone number. The web page may further include an instruction to call the premium rate phone number through the mobile phone for payment of the selected goods/services, and a first predefined time period for completing the transaction.

In another embodiment, the payment management system 106 sends a short message service (SMS) to the mobile phone number before displaying the premium rate phone number in the web browser 112. The SMS may include a verification code of four digits, and the user may be prompted to enter the verification code into a predefined field in the web browser 112. When the verification code is correctly entered, the payment management system 106 displays the premium rate phone number. In various embodiments, the database 109 stores at least one mobile phone number, and corresponding premium rate phone numbers and payment requests.

In step 208, the web shop 104 accesses information such as frame/script etc. needed to authorize at least one payment request, from the payment management system 106. In step 210, the payment management system 106 adds information related to respective payment method on a web page of the web shop 104, so as to enable the user to be redirected to a web page of the payment management system 106 when they select the payment management system 106 as a payment method for the selected goods/services.

In step 212, the user calls the premium rate phone number from the mobile phone 110. In an embodiment, when the mobile phone 110 is a smart phone and the web browser 112 executes on the mobile phone 110, the user may not need to dial the premium rate phone number, and may use the touch screen interface of the mobile phone 110 to tap the displayed premium rate phone number with finger and automatically call the premium rate phone number.

In step 214, the call routing logic 114 and the billing system 116 communicates with each other, to verify whether a caller of the premium rate phone number has sufficient funds in their respective mobile phone account to pay for the call. When there are insufficient funds in the mobile phone account, the call routing logic 114 rejects the incoming call, and after the expiry of the first predefined time period, the payment management system 106 provides a notification in the web browser 112, that the payment could not be processed further.

In step 216, the call routing logic 114 forwards the incoming call for the premium rate phone number to the payment management system 106, when there are sufficient funds in the mobile phone account of the caller. The payment management system 106 also receives the mobile phone number of the caller along with the forwarded call.

In step 218, the payment management system 106 answers the incoming call with a predefined audio message. In an exemplary embodiment, the predefined audio message includes “Please hold we are processing your payment”. While the audio message is played, the payment management system 106 verifies whether the mobile phone number of the caller is same as the mobile phone number received in the payment request. The payment management system 106 continues playing the predefined audio message for almost a second predefined time period when the mobile phone number of the caller is same as the mobile phone number in the payment request. Alternatively, the payment management system 106 terminates the incoming call before the expiry of the second predefined time period when the mobile phone number of the caller is not similar to the mobile phone number in the payment request, and after the expiry of the first predefined time period, the payment management system 106 provides a notification in the web browser 112, that the payment could not be processed further.

In step 220, a success of the incoming call is automatically indicated to the call routing logic 114 when the incoming call continues for almost the second predefined time period. Alternatively, a failure of the incoming call is automatically indicated to the call routing logic 114 when the incoming call is dropped before the expiry of the second predefined period. For example, if the incoming call is continued for 10 seconds, it is a success, else it is a failure.

In step 222, the call routing logic 114 informs the payment management system 106 when the incoming call has been successful and call charges have been paid from the mobile phone account of the user. In step 224, the payment management system 106 informs the webshop 104 that the payment for the selected goods/services has been successfully done from the user mobile account. In step 226, the billing system 116 credits all or a part of the call charges to the payment management system 106. In step 228, the payment management system 106 pays the webshop 104 for the selected goods/services. In step 230, the web shop 104 sends a message to the web browser 112, that the payment for selected goods/services has been received and the delivery of the goods/services may be initiated.

In an exemplary embodiment, the user may select a product having a price equal to 5 [symbol] , however, in order to pay through the payment management system 106, the user may have to pay a service fee of 2 [symbol] , thus bringing up the total price of the selected product to 7 [symbol] . Accordingly, the payment management system 106 may provide a premium rate phone number that has associated therewith a value equal or equivalent to 7 [symbol] to the user. This can also be referred to as the price of the call. When the user makes a successful call to the premium rate phone number, 7 [symbol] are deducted from his mobile phone account, and all or part of the 7 [symbol] is credited to the payment management system 106, and the payment management system 106 pays or otherwise distributes 5 [symbol] to the web shop 104.

FIG. 2 is merely an example, which should not unduly limit the scope of the claims herein. One of ordinary skill in the art would recognize many variations, alternatives, and modifications of embodiments herein.

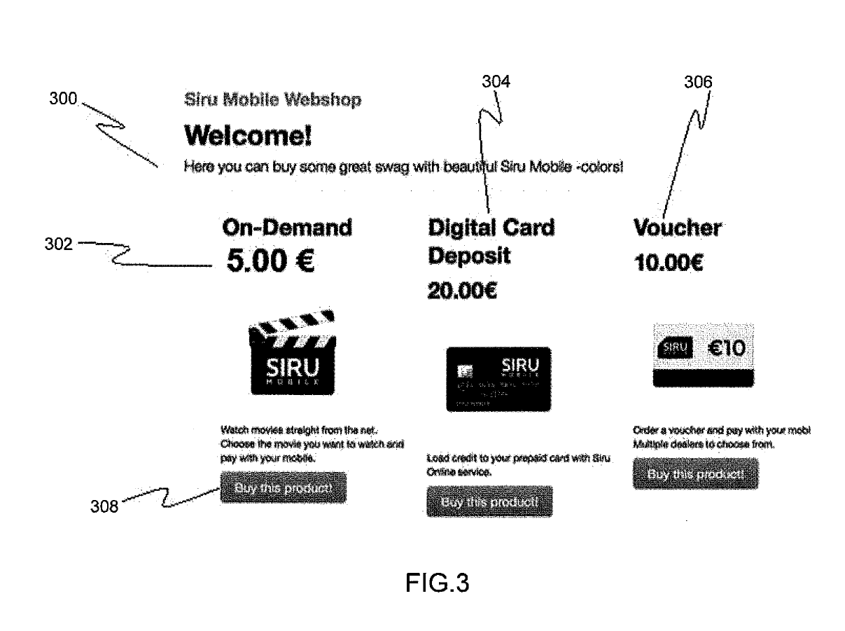

FIG. 3 is an illustration of an exemplary web page 300 of the web shop 104, displayed in the web browser 112, in accordance with the present disclosure. The web page 300 includes products like on-demand video service 302, a digital card deposit service 304 to load pre-paid credit card with funds, and a voucher service 306 to make a voucher to be used to pay with a mobile phone. For each product, there is provided an icon to select and buy the corresponding product. In an example, the icon 308 is provided to select and buy the on-demand video service 302.

FIG. 3 is merely an example, which should not unduly limit the scope of the claims herein. One of ordinary skill in the art would recognize many variations, alternatives, and modifications of embodiments herein.

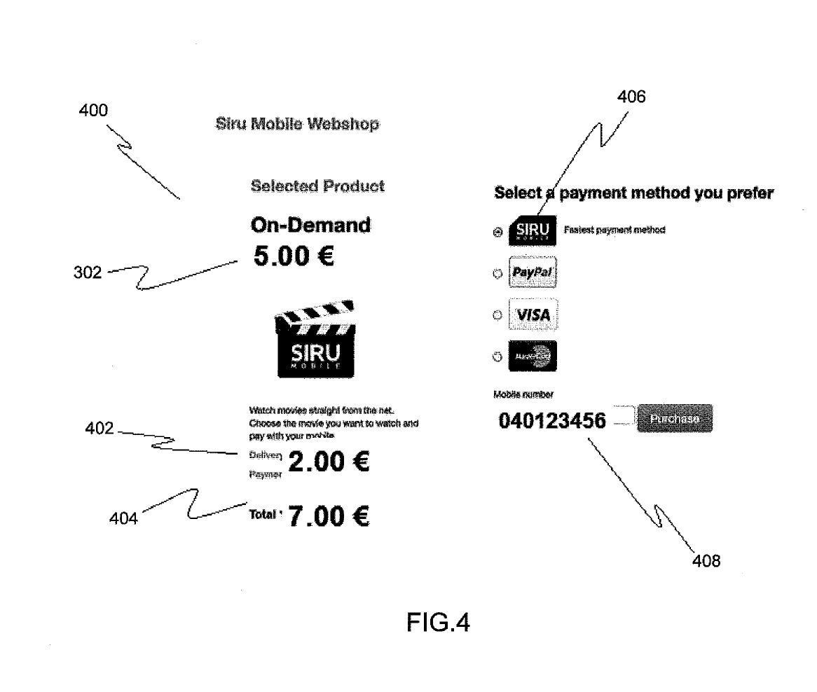

FIG. 4 is an illustration of an exemplary payment page 400 of the web shop 104, displayed in the web browser 112, in accordance with the present disclosure. In an embodiment, the user is redirected to the payment page 400, after the user selects the on-demand video service 302 of 5 [symbol] on the web page 300. The payment page 400 displays the selected product 302 along with its price, a service fee 402 of 2 [symbol] , and a total amount 404 of 7 [symbol] . The payment page 400 further provides multiple payment options like ‘SIRU mobile’ 406, which is an example of the payment management system 106, PayPal, VISA, and MasterCard, and a predefined field 408 for prompting the user to fill in their mobile phone number.

FIG. 4 is merely an example, which should not unduly limit the scope of the claims herein. One of ordinary skill in the art would recognize many variations, alternatives, and modifications of embodiments herein.

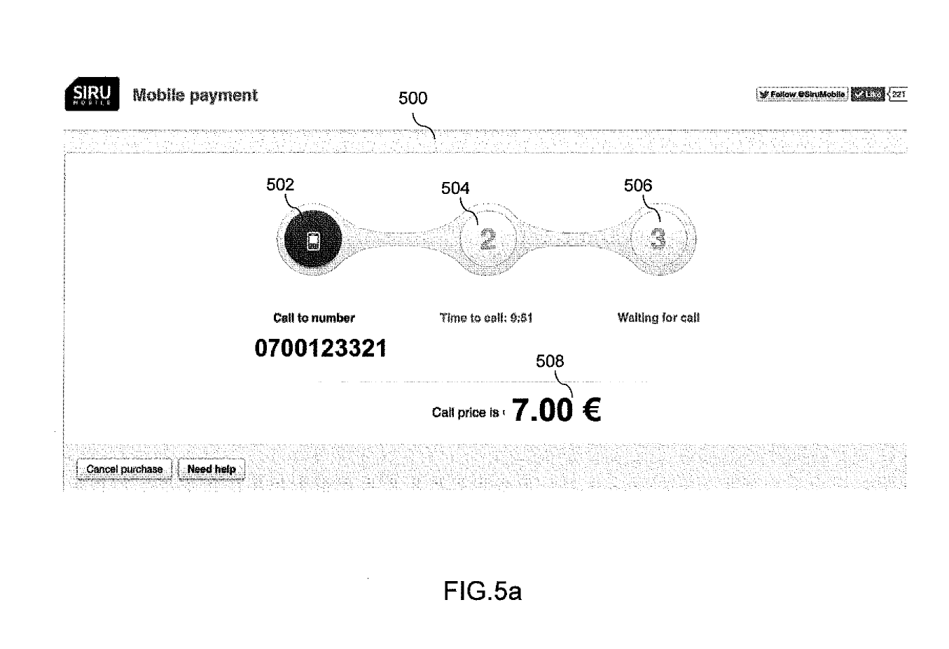

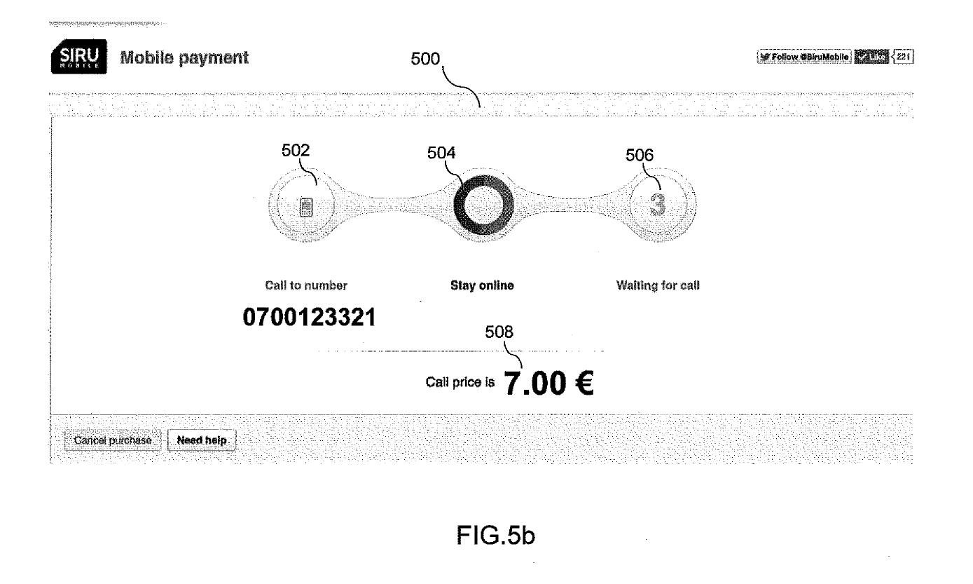

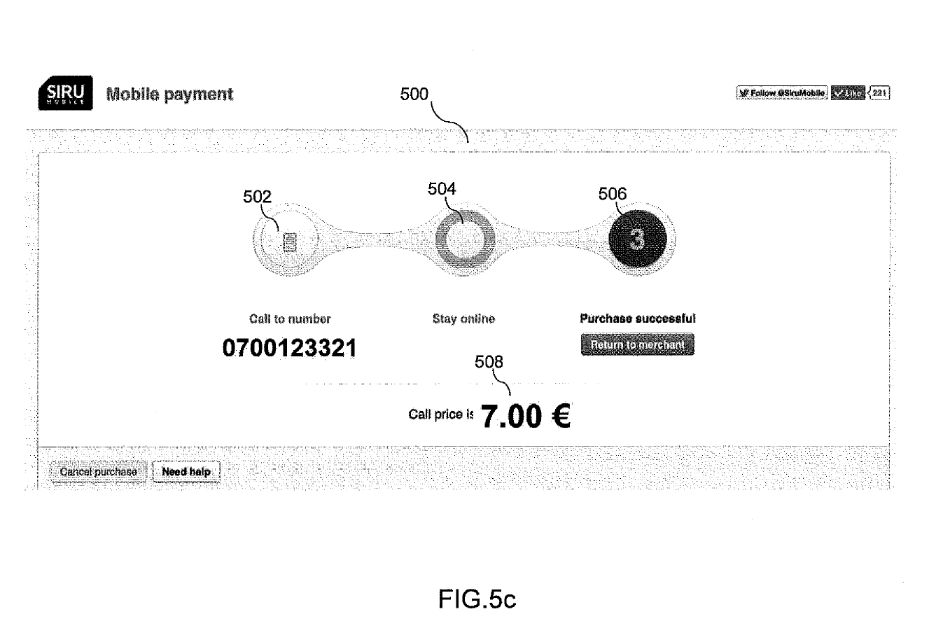

FIG. 5a is an illustration of an exemplary web page 500 of the payment management system 106 displayed in the web browser 112, in accordance with the present disclosure. In an embodiment, the user is redirected to the web page 500 after he clicks/taps on the ‘SIRU mobile’ 406 of the payment page 400 and enters their mobile phone number in the predefined field 408. The web page 500 includes a first icon 502 for displaying and instructing the user to call a premium rate phone number, i.e, 0700123321, a second icon 504 for displaying the time left to call the premium rate phone number, a third icon 506 for displaying a status of the call to the premium rate phone number, and an overall price 508 of the selected product 302. In an embodiment, the payment management system 106 is continuously in communication with the mobile phone operator infrastructure 108, and any update regarding a call to the premium rate phone number is updated on the web page 500.

FIG. 5b is an illustration of the web page 500 when the user calls the premium rate phone number, i.e., 0700123321. The second icon 504 instructs or otherwise indicates to the user to stay online when the call is being received by the payment management system 106, and is continued for the at least second predefined period to indicate success of the call to the call routing logic 116. The second icon 504 can provide a visual indication of the instruction. In one embodiment, an audio indication can be associated therewith. In an exemplary embodiment, the user may be asked to hold the call and stay online until at least 10 seconds of the call has taken place, meaning that the call is active for a pre-determined period of time.

FIG. 5c is an illustration of the web page 500, in which the third icon 506 illustrates that the purchase has been successful, when the call to the premium rate phone number is successfully continued for the at least second predefined period. The third icon 506 can provide a visual indication that the purchase was successful. In one embodiment, an audio indication might also be provided. Accordingly, 7 [symbol] are deducted from the mobile phone account of the user (when the account is prepaid) and 7 [symbol] are added to an overall bill of the mobile phone account (if the account is postpaid). The billing system 116 credits all or a part of 7 [symbol] to the payment management system 106, which in turn pays 5 [symbol] to the web shop 104, i.e. merchant for the selected product 302.

FIGS. 5a, 5b and 5c are merely examples, which should not unduly limit the scope of the claims herein. One of ordinary skill in the art would recognize many variations, alternatives, and modifications of embodiments herein.

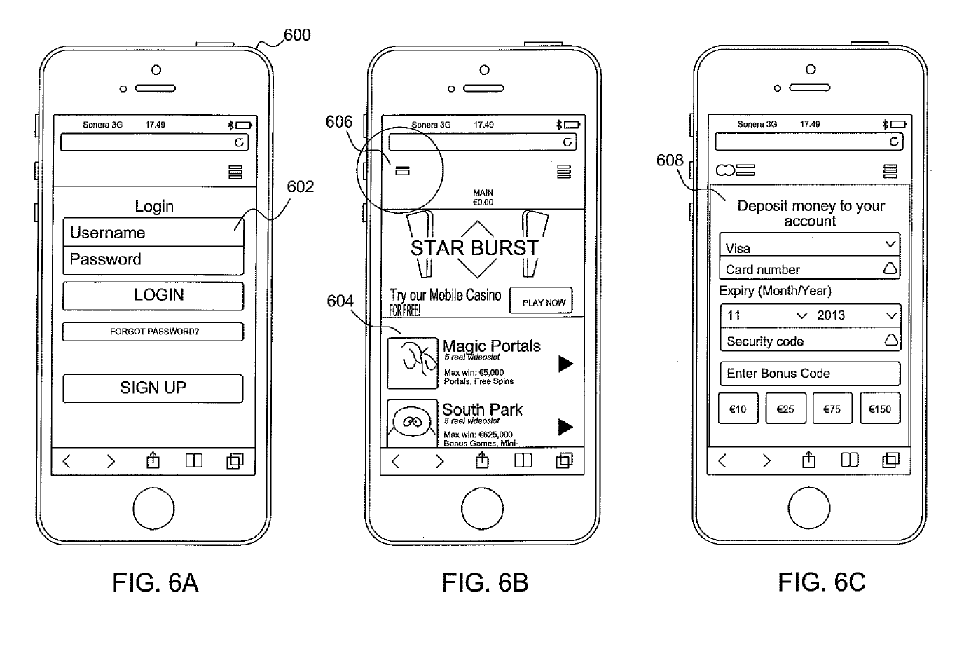

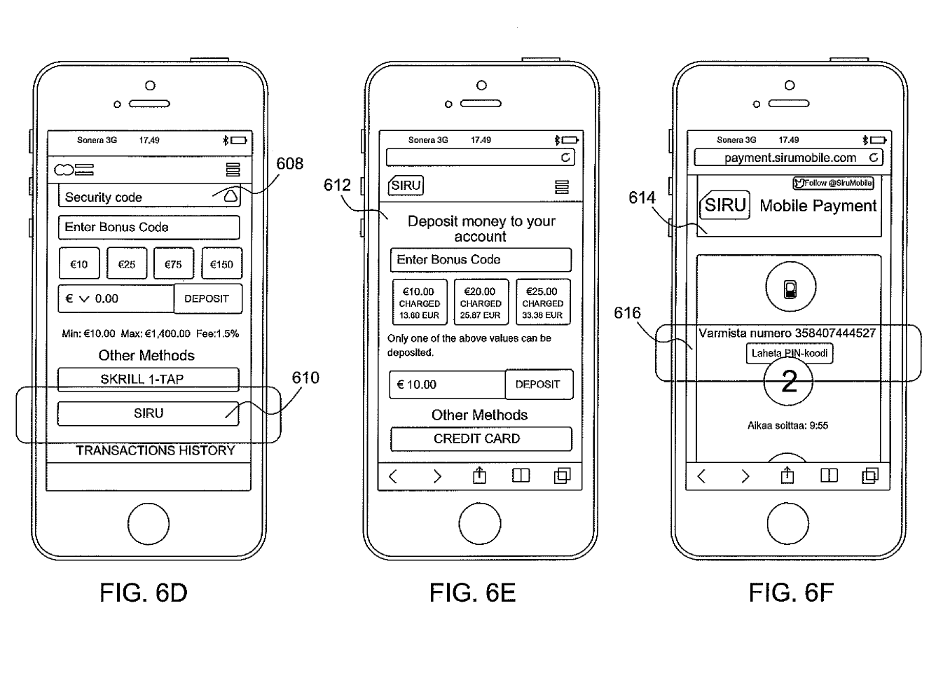

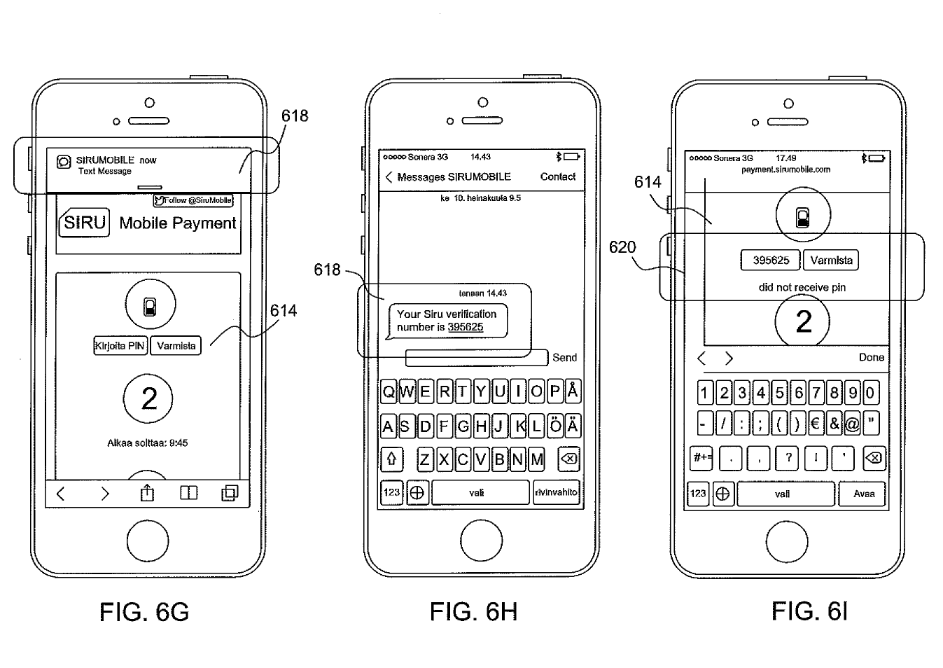

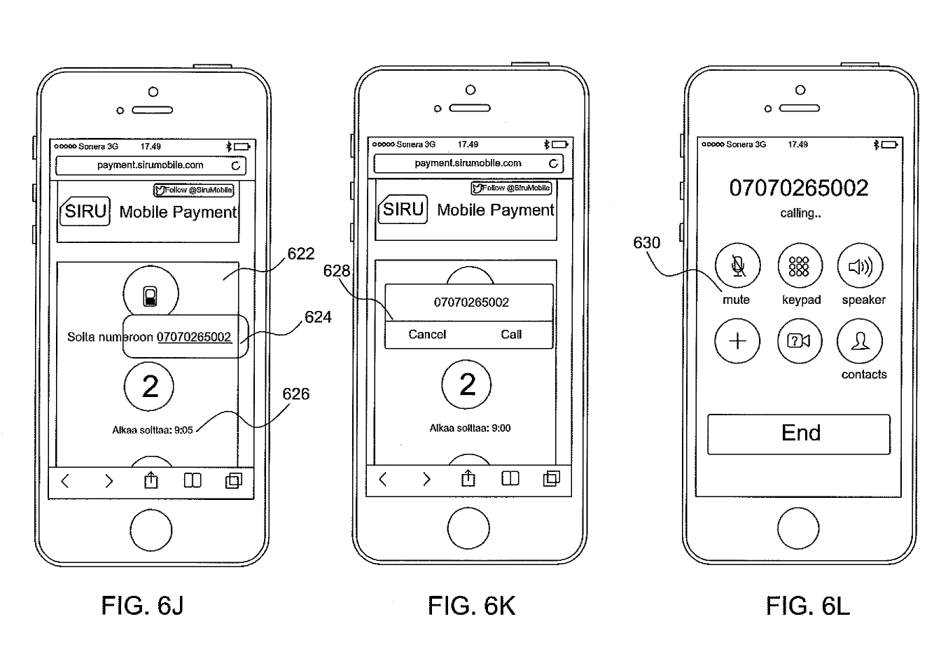

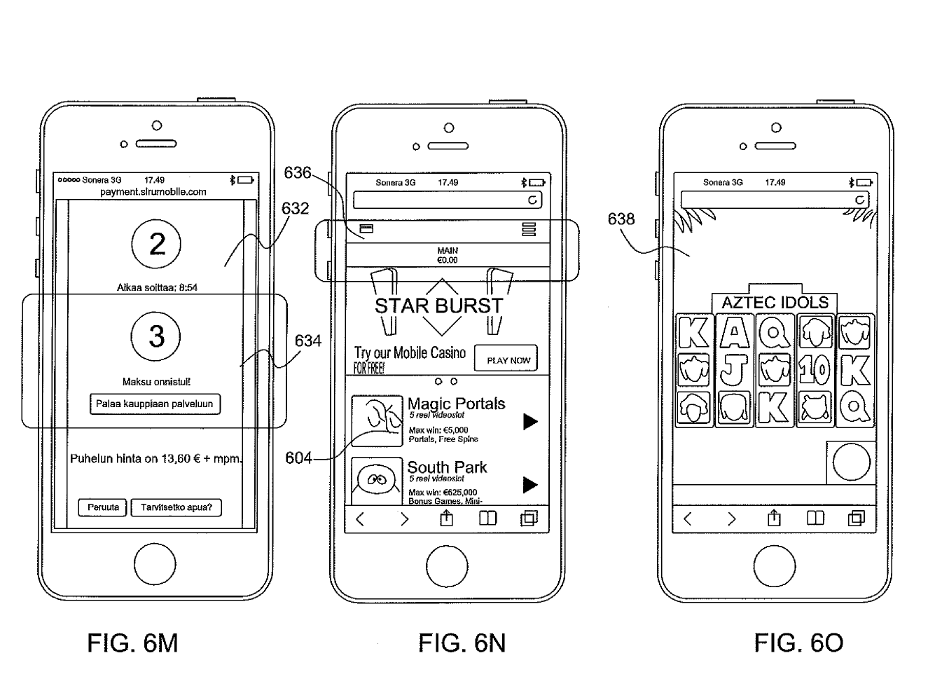

FIG. 6a is an illustration of a web page 602 being displayed in a web browser of a smart phone 600, which is an example of the mobile phone 110, in accordance with the present disclosure. The smart phone 600 is connected to a communication network such as Internet through communication means of WiFi, WLAN, cellular (2G, 3G, LTE etc). The web page 602 is of a gaming website (an example of the web shop 104) and enables the user to create a gaming account and login into the gaming account using a username and password.

FIG. 6b is an illustration of another web page 604 being displayed in the web browser of the smart phone 600. In an embodiment, the user is directed to the web page 604 after he fills in the username and password on the web page 602. The web page 604 displays a list of games and also an icon 606 at an upper leftmost corner to enable the user to pay for one or more games or add a deposit amount to their gaming account.

FIGS. 6c and 6d are an illustration of another exemplary web page 608 being displayed in the web browser of the smart phone 600. In an embodiment, the user is directed to the web page 608 after he clicks or taps on the icon 606 of the web page 604. The web page 608 displays one or more icons corresponding to payment options such as credit/debit card payment and ‘SIRU’ payment system 610, which is an example of the payment management system 106.

FIG. 6e is an illustration of another exemplary web page 612 being displayed in the web browser of the smart phone 600. In an embodiment, the user is directed to the web page 612 after he taps or clicks on the icon corresponding to ‘SIRU’ payment system 610. On the web page 612, the user may select a desired amount to be deposited into their gaming account. The web page 612 also displays information about SIRU payment system 610, pricing and other relevant details.

FIGS. 6f and 6g are an illustration of an exemplary web page 614 of the Siru payment system 610 being displayed in the web browser of the smart phone 600. In an embodiment, the user is directed to the web page 614 after he taps on the deposit amount on the web page 612. The web page 614 includes an icon 616 “Send pin”. When the user taps on the icon 616, an SMS containing verification PIN may be sent to the smart phone 600, and the smart phone 600 instantly receives an SMS 618 containing the verification PIN.

FIG. 6h is an illustration of the SMS 618 containing the verification PIN, i.e. 395625. The verification PIN is a set of numbers which identifies the phone mobile number of the smart phone 600. In an embodiment, the SMS verification is performed only once, i.e., when the user uses the SIRU payment system 610 for the first time.

FIG. 6i is an illustration of the web page 614 that includes a field 620 for enabling the user to fill in the verification PIN received in the SMS 618. After entering the verification PIN, the user may tap on the ‘confirm’ icon.

FIG. 6j is an illustration of a web page 622 being displayed in the web browser of the smart phone 600, after the user taps/clicks on the ‘confirm’ icon on the web page 614. The web page 622 displays a premium rate phone number 624, a time window 626 of how long the transaction is active or till how long the call to the premium rate phone number can be made, cancellation links and FAQs. In an embodiment, the premium rate number 624 may be displayed based on the total deposit amount of the user and a country of the user.

FIG. 6k is an illustration of the smart phone 600 providing an option 628 to enable the user to call the premium rate phone number 624. The smart phone 600 switches to the phone function to enable the user to make a call to the premium rate phone number 624.

FIG. 6l is an illustration of a user interface 630 of the smart phone 600 when a call to the premium rate phone number 624 is in progress. The call may continue for about 10-15 seconds, during which the user may hear the call price, may be asked to hold the call, and then hear a confirmation of a successful payment.

FIG. 6m is an illustration of a web page 632 being displayed in the web browser of the smart phone 600, after the call to the premium rate number 624 is terminated. The web page 632 displays a confirmation 634 of the successful call and successful payment of the deposit amount in the gaming account.

FIG. 6n is an illustration of the web page 604 for displaying the deposit amount 636 in the gaming account of the user. In an embodiment of the present invention, the user returns to the web page 604 after the web page 632 displays the confirmation 634 of the successful payment of the deposit amount.

FIG. 6o is an illustration of the web page 638 being displayed in the web browser of the smart phone 600, for displaying playing of games like jackpot hunting by the user.

FIG. 6a-6o are merely examples, which should not unduly limit the scope of the claims herein. One of ordinary skill in the art would recognize many variations, alternatives, and modifications of embodiments herein.

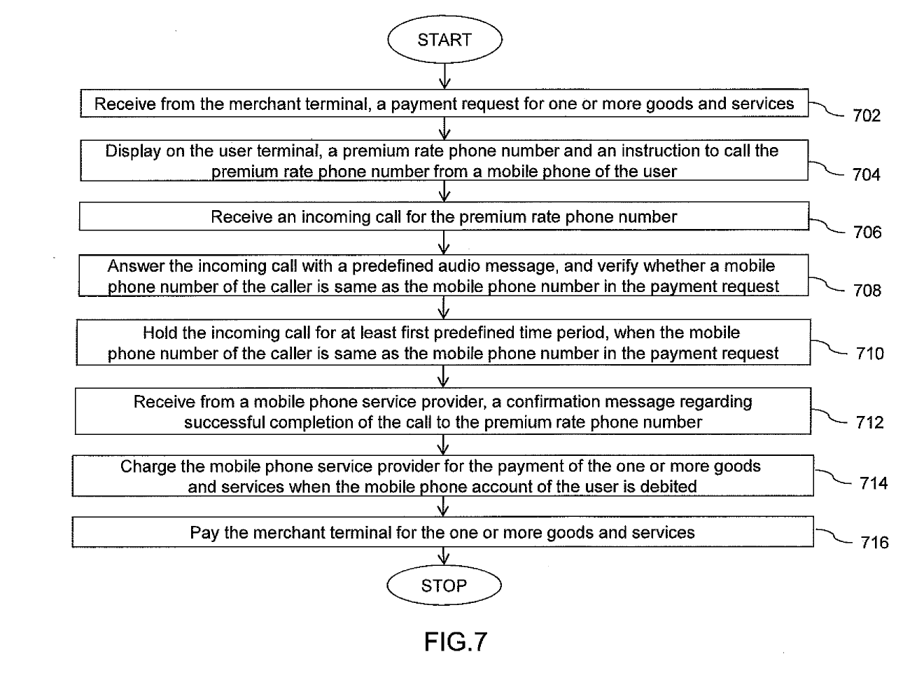

FIG. 7 is an illustration of steps of a method of processing electronic payments between user and merchant terminals through a payment management system 106, in accordance with the present disclosure, and has been explained in conjunction with FIG. 1. The method is depicted as a collection of steps in a logical flow diagram, which represents a sequence of steps that can be implemented in hardware, software, or a combination thereof.

At a step 702, the payment management system 106 receives a payment request from a merchant terminal such as the web shop 104, for payment towards one or more goods and services. The payment request includes a mobile phone number of a user such as a mobile phone number of the mobile phone 110.

At a step 704, the payment management system 106 displays on the user terminal such as the user device 102, a premium rate phone number and an instruction to call the premium rate phone number from the mobile phone 110. The premium rate phone number is associated with a value of the one or more goods and services.

At a step 706, the payment management system 106 receives an incoming call for the premium rate phone number, wherein the incoming call is forwarded by the mobile phone service provider 114 when a mobile phone account of a caller has sufficient funds to pay for an outgoing call to the premium rate phone number.

At a step 708, the payment management system 106 answers the incoming call with a predefined audio message, and verify whether a mobile phone number of the caller is same as the mobile phone number in the payment request.

At a step 710, the payment management system 106 holds the incoming call for at least first predefined time period, when the mobile phone number of the caller is same as the mobile phone number in the payment request.

At a step 712, the payment management system 106 receives a confirmation message from the mobile phone service provider 108 regarding successful completion of the call to the premium rate phone number and debiting of the mobile phone account of the user for the call, when the incoming call is held for the at least first predefined time period.

At a step 714, the payment management system 106 charges the mobile phone service provider for the payment of the one or more goods and services when the mobile phone account of the user is debited.

At a step 716, the payment management system 106 pays the merchant terminal such as web shop 104 for the one or more goods and services.

It should be noted here that the steps 702 to 716 are only illustrative and other alternatives can also be provided where one or more steps are added, one or more steps are removed, or one or more steps are provided in a different sequence without departing from the scope of the claims herein.

FIG. 7 is merely an example, which should not unduly limit the scope of the claims herein. One of ordinary skill in the art would recognize many variations, alternatives, and modifications of embodiments herein.

Although embodiments of the present invention have been described comprehensively in the foregoing, in considerable detail to elucidate the possible aspects, those skilled in the art would recognize that other versions of the invention are also possible.

We claim:

1. A payment management system for processing electronic payments between user and merchant terminals, wherein the payment management system includes a computing hardware coupled in communication via a communication network to the user and merchant terminals, and a mobile phone service provider, and is operable to execute one or more software products for providing a graphical user interface on the user terminal, wherein the computing hardware of the payment management system is operable to:
receive from the merchant terminal, a payment request for one or more goods and services, wherein the payment request includes a mobile phone number of a user;
display on the user terminal, a premium rate phone number and an instruction to call the premium rate phone number from a mobile phone of the user, wherein the premium rate phone number is associated with a value of the one or more goods and services;
receive an incoming call for the premium rate phone number, wherein the incoming call is forwarded by the mobile phone service provider when a mobile phone account of a caller has sufficient funds to pay for an outgoing call to the premium rate phone number;
answer the incoming call with a predefined audio message, and verify whether a mobile phone number of the caller is same as the mobile phone number in the payment request;
hold the incoming call for at least first predefined time period, when the mobile phone number of the caller is same as the mobile phone number in the payment request;
receive from a mobile phone service provider, a confirmation message regarding successful completion of the call to the premium rate phone number and debiting of the mobile phone account of the user for the call, when the incoming call is held for the at least first predefined time period;
charge the mobile phone service provider for the payment of the one or more goods and services when the mobile phone account of the user is debited; and
pay the merchant terminal for the one or more goods and services.

2. The payment management system as claimed in claim 1, wherein the computing hardware of the payment management system is further operable to decline the payment to the merchant terminal, when the user does not call the premium rate phone number within a second predefined time period, and/or when the user does not have sufficient funds in corresponding mobile phone account, and/or when the caller of the premium rate phone number is not same as the user, and/or when the user terminates the outgoing call to the premium rate phone number before the expiry of the first predefined time period.

3. The payment management system as claimed in claim 1, wherein the computing hardware of the payment management system is further operable to terminate the incoming call to the premium rate phone number before the expiry of the first predefined time period, when the mobile phone number of the caller is not same as the mobile phone number in the payment request.

4. The payment management system as claimed in claim 1, wherein the computing hardware of the payment management system is further operable to access at least one database that stores the mobile phone number of the user, and corresponding premium rate phone number and the payment request.

5. The payment management system as claimed in claim 1, wherein the computing hardware of the payment management system is further operable to send a short message service (SMS) to the mobile phone of the user before displaying the premium rate phone number on the user terminal, wherein the SMS includes a verification code for enabling the user to enter the verification code in a predefined field on the graphical user interface of the user terminal.

6. The payment management system as claimed in claim 1, wherein the computing hardware of the payment management system is further operable to display on the user terminal, a status update of the call between the mobile phone number of the user and the premium rate phone number, when the user calls at the premium rate phone number from their mobile phone.

7. The payment management system as claimed in claim 1, wherein the user terminal is a computing device implemented using at least one of: a laptop, a personal computer, a tablet computer, a phablet computer, a webpad, a wearable computer, a wrist-worn computer, and a smart phone.

8. A method for processing electronic payments between user and merchant terminals through a payment management system, wherein the payment management system includes a computing hardware coupled in communication via a communication network to the user and merchant terminals, and a mobile phone service provider, and is operable to execute one or more software products for providing a graphical user interface on the user terminal, wherein the method includes operating the computing hardware of the payment management system to:
receive from the merchant terminal, a payment request for one or more goods and services, wherein the payment request includes a mobile phone number of a user;
display on the user terminal, a premium rate phone number and an instruction to call the premium rate phone number from a mobile phone of the user, wherein the premium rate phone number is associated with a value of the one or more goods and services;
receive an incoming call for the premium rate phone number, wherein the incoming call is forwarded by the mobile phone service provider when a mobile phone account of a caller has sufficient funds to pay for an outgoing call to the premium rate phone number;
answer the incoming call with a predefined audio message, and verify whether a mobile phone number of the caller is same as the mobile phone number in the payment request;
hold the incoming call for at least first predefined time period, when the mobile phone number of the caller is same as the mobile phone number in the payment request;
receive from a mobile phone service provider, a confirmation message regarding successful completion of the call to the premium rate phone number and debiting of the mobile phone account of the user for the call, when the incoming call is held for the at least first predefined time period;
charge the mobile phone service provider for the payment of the one or more goods and services when the mobile phone account of the user is debited; and
pay the merchant terminal for the one or more goods and services.

9. The method as claimed in claim 8, wherein the method further includes operating the computing hardware of the payment management system to decline the payment to the merchant terminal, when the user does not call the premium rate phone number within a second predefined time period, and/or when the user does not have sufficient funds in corresponding mobile phone account, and/or when the caller of the premium rate phone number is not same as the user, and/or when the user terminates the outgoing call to the premium rate phone number before the expiry of the first predefined time period.

10. The method as claimed in claim 8, wherein the method further includes operating the computing hardware of the payment management system to terminate the incoming call to the premium rate phone number before the expiry of the first predefined time period, when the mobile phone number of the caller is not same as the mobile phone number in the payment request.

11. The method as claimed in claim 8, wherein the method further includes operating the computing hardware of the payment management system to access at least one database that stores the mobile phone number of the user, and corresponding premium rate phone number and the payment request.

12. The method as claimed in claim 8, wherein the method further includes operating the computing hardware of the payment management system to send a short message service (SMS) to the mobile phone of the user before displaying the premium rate phone number on the user terminal, wherein the SMS includes a verification code for enabling the user to enter the verification code in a predefined field on the graphical user interface of the user terminal.

13. The method as claimed in claim 8, wherein the method includes operating the computing hardware of the payment management system to display on the user terminal, a status update of the call between the mobile phone number of the user and the premium rate phone number, when the user calls at the premium rate phone number from their mobile phone.

14. The method as claimed in claim 8, wherein the user terminal is a computing device implemented using at least one of: a laptop, a personal computer, a tablet computer, a phablet computer, a webpad, a wearable computer, a wrist-worn computer, and a smart phone.

15. A software product recorded on non-transitory machine-readable data storage media, wherein the software product is executable upon the computing hardware of the payment management system for executing the method as claimed in claim 8.
